(19) United States
(12) Patent Application Publication
(10) Pub. No.: US 2014/0280944 A1
(43) Pub. Date: Sep. 18, 2014

(54) EDUCATIONAL CONTENT ACCESS CONTROL SYSTEM

(71) Applicants: John Montgomery, San Jose, CA (US); Andre L. Marais, San Jose, CA (US)

(72) Inventors: John Montgomery, San Jose, CA (US); Andre L. Marais, San Jose, CA (US)

(21) Appl. No.: 14/212,069

(22) Filed: Mar. 14, 2014

Related U.S. Application Data
(60) Provisional application No. 61/793,402, filed on Mar. 15, 2013.

(51) Int. Cl. H04L 29/08

(52) U.S. Cl. CPC H04L 67/10
USPC 709/225

(57) ABSTRACT

A method of automatically controlling access to applications accessible on or via a computing device is automatically performed. The method enables access, by a user, to a first application via the computing device, while concurrently disabling access to a second application. Using at least one processor, a predetermined amount of engagement by the user with the first application is detected. Responsive to the detection of the predetermined amount of engagement, access to the second application via the computing device is selectively enabled.

### CLAIM OF PRIORITY

The present application claims the benefit of priority under 35 U.S.C. §119(e) of U.S. Provisional Patent Application 61/793,402, filed Mar. 15, 2013, the disclosure of which is hereby incorporated by reference herein in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This patent document pertains generally to access control on computing devices, and more particularly, but not by way of limitation, to an educational content access control system.

### BACKGROUND

Within the home environment, children are increasingly being provided with access to multiple computing systems (e.g., in the form of mobile devices, such as smart phones and tablets, or more traditional computers). Similarly, computing devices are increasingly being deployed within educational environments in order to provide students with access to educational applications and content. While these computing devices provide access to desired educational applications and content, they simultaneously provide children and students with access to a far broader range of content and applications.

Taking the tablet computing device as an example, many schools are now issuing these to their students (or at least requiring that students have access to such a tablet computing device), and migrating from traditional printed textbooks to digital versions of such textbooks, which the students are then required to access on the tablet computing device. Additionally, students are being asked to access a wide variety of school-related content (e.g., calendars, teacher websites, online videos etcetera) via browser applications hosted on these tablet computing devices.

Students are also typically free to install other applications on their tablet computing devices, such as entertainment applications (e.g., game applications, music access applications, video viewing applications etcetera). Many of these entertainment-centric applications provide a distraction for students. The temptation to engage with these entertainment-related applications at times when they should be engaging with education-related applications should not be underestimated.

The wide variety of content and applications that are accessible on computing devices to children and students present a number of challenges to parents, teachers and supervising users. Specifically, it is difficult for parents or teachers to continually monitor that a student is involved with educational activities, and engaging with a specific educational application or content, during a homework time, study time or class, as opposed to playing a game or accessing other entertainment-related content.

While policing a child's activity on a mobile computing device may sometimes be possible, continually doing so may prove unpleasant for a parent or teacher. Further, the mobility of modern computing devices may make it impractical for manual parental monitoring to be performed. Even further, where a large number of users are apparently using computing devices in a communal environment (e.g., within a classroom environment), it becomes practically very difficult for a teacher to ensure that the students are engaging with relevant applications and content.

In short, by providing children and students with powerful modern computing devices, such as the iPad tablet, parents and educators are providing children with powerful educational tools, but concurrently providing them with highly tempting and engaging entertainment systems. The problem of ensuring that desired applications and content are being accessed at an appropriate time and/or not providing a distraction prior to completion of educational use of a computing device presents a number of technical challenges with respect to, for example, monitoring of user engagement activities and access restrictions and permissions.

### BRIEF DESCRIPTION OF DRAWINGS

Some embodiments are illustrated by way of example and not limitation in the figures of the accompanying drawings in which:

FIG. 1 is a diagrammatic representation of a networked computing in environment in which an access control system, according to an example embodiment, may be deployed.

FIG. 2 is a block diagram showing a mobile device software architecture within which an access control application, according to an example embodiment, may be incorporated.

FIG. 3 is a block diagram illustrating architectural details of an access control application, according to an example embodiment.

FIG. 4 is an entity-relationship diagram illustrating tables of an access control data structure, accessible by an access control application, according to an example embodiment.

FIG. 5 is a flowchart illustrating a method, according to an example embodiment, to automatically control access to applications on a computing device.

FIG. 6 is a flowchart illustrating a method, according to an example embodiment, to determine and calculate engagement of a user with a particular content or a particular application.

FIG. 7 is a flowchart illustrating a method, according to a further example embodiment, in order to provide location-based access control to applications and content on a portable computing device.

FIG. 8 is a user interface diagram illustrating a supervising user interface, according to an example embodiment, that may be presented to a supervising user in order to solicit specification of control data.

FIG. 9 is a user interface diagram illustrating a student user interface, according to an example embodiment, in which a first set of applications have been enabled by an access control application for access by a student user while a second set of applications have been disabled.

FIG. 10 is a user interface diagram illustrating a student user interface, according to an example embodiment, in which a reward message is presented to a student user.

FIG. 11 is a block diagram of a machine, in the example form of a computer system, within which a set of instructions, for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Example embodiments include an access control system that can be deployed, for example, to permit access to specific content and applications (e.g., educational content and applications), while restricting (e.g., disabling or preventing) access to other content and applications (e.g., entertainment or content or applications) under certain specified conditions. In one example embodiment, the conditions under which access control may be enforced may relate to a required amount of usage of and/or engagement (or activity) with a specified resource (e.g., an educational application and/or content). For example, the access control system may only permit access by a child to an entertainment application (e.g., a game application) once the child has performed a measurable and specified engagement with an educational application.

Once the specified amount of usage or engagement with the educational application have been complete, the access control system may then automatically enable access to the game application (or provide some other form of reward) to the child as a result of having completed engagement with the educational application. In this embodiment, an amount of usage of the gaming application may be directly related (e.g. proportional to) the amount of engagement with the educational application. For example, ten minutes of engagement with an educational application may earn a child five minutes of play time with the gaming application.

Rewards other than access to otherwise restricted content and applications may also be provided. For example, a random “Easter egg” reward may be presented to a child user on completion of a predetermined amount of engagement and/or usage of an educational application. The reward “Easter egg” may be randomly selected from a predefined set of rewards. Such rewards may also include access to an online music video, changing the background of a computer system (e.g., where the screensaver or wallpaper of the computer system is modified in a rewarding way), the presentation of virtual coins or medals, the presentation of real money reward (e.g., pocket money), or the presentation of reward messages (e.g., praise for having completed a certain amount of educational activity).

In a further embodiment, the access control system may also permit or enable access to educational content and applications within a specific geographical location or area, while concurrently restricting or disabling access to other resources (e.g., entertainment applications and content) within the specified geographic location or area. In one example embodiment, the geographic area may be defined as “geofence” that is automatically determined by a computer system based on any one or more of Global Positioning System (GPS) data, Near Field Communication (NFC) data or a network (e.g., wireless) data. For example, the access control system may be used to control access to different types of applications with differing degrees of geographic specificity.

Consider the example of a high school campus. Here, the access control system may, in one example embodiment, operate to permit access, on campus, to a predefined set of applications installed on the mobile computer systems (e.g., iPads) of students, permit access to certain types of content, while concurrently restricting or disabling access to certain applications and other types of content (e.g., disabling access to entertainment related content and applications). In this example embodiment, the access control system may enable access control to be implemented on the individual mobile devices based on geographic location, as opposed to requiring that access control be enforced by a network provider (e.g., by OpenDNS). The migration of the access control from, for example, a router supporting a school-provided network is advantageous in that it prevents bypassing of that network (e.g., via the cellular data network) by the mobile devices of students.

The access control system may also operate at a higher degree of geographic resolution (e.g., within a specific classroom) to restrict access to applications and content that are appropriate and relevant to a class being taught within that classroom at a specific time. For example, in one embodiment, a teacher is provided with an interface that allows the teacher to specify that only certain applications and/or content are accessible to students within the classroom for the duration of a particular class. In this way, the teacher may be assured that students, while working on their portable computing devices, are not accessing applications and content not related to the class being presented. The access control system in this way removes the burden from the teacher of policing student activity.

In a further embodiment, the location-based and activity/engagement constrained access control capabilities, described above, may be combined. In such embodiments, access to certain applications and content may be constrained or restricted based on a location until completion of a predetermined amount of engagement (e.g., work or activity), whereafter access to a broader range of content and applications may be permitted. Consider an example where, within a classroom environment, the teacher may specify that a predetermined number of math problems need to be completed, whereafter the students are permitted “free time”, in which they can access non-educational content (or other content not directed related to the subject being taught in that class).

In addition to making the expanded access contingent purely on amount of engagement or activity, the broader access may also be made contingent upon achieving a certain result within the activity (e.g., obtaining a certain score on a number of quiz questions). In this way, the activity/engagement constraints may be combined with the location-based constraints to enable a teacher to restrict access to pertinent material, while at the same time providing an incentive for the students to complete the required activities or engagements.

According to one example embodiment, there is provided a method to automatically control access to applications and/or content accessible by a portable computing device. The method includes enabling access, by a student user for example, to a first application (e.g., an educational application) via the portable computing device, while concurrently disabling (or otherwise restricting) access to a second application (e.g., an entertainment application) that would have otherwise been accessible via the portable computing device. A predetermined amount or degree of engagement, by the student user with the first application, is detected. Responsive to the detection of this predetermined amount of engagement, access to the second application, via the computing device, is selectively enabled (or restrictions with respect to access to the second application may be removed).

The first application may be an educational application (e.g., that enables access exclusively to educational content), and the second application may be a recreational or entertainment application (e.g., that enables access to a recreational or entertainment content).

The disabling (or restricting) of the access to the second application may include retrieving control data and determining from the control data that access to the second application is to be restricted until detection of the predetermined amount of engagement with the first application. The control data may specify the predetermined amount of engagement by the student user with the first application.

Input may be received from a supervising user (e.g., a teacher), responsive to which the control data is automatically generated. To this end, the supervising user (e.g., the teacher) may be solicited for information used to construct the control data. The solicited information may include the identity of a student user (or users), identification of the first application (e.g., the educational application) with which engagement is required, a required amount of engagement with the first application, and also identification of a second application (e.g., the recreational or entertainment application) for which access restrictions are to be removed as a reward for completing the required amount of engagement.

Detecting the predetermined amount of engagement may include measuring a duration of time that the student user engages with the first application. Detecting the predetermined amount of engagement may also include measuring an amount of activity (e.g., pages of an electronic textbook read) performed by the student user with respect to the first application, measuring or monitoring input by the user with respect to the application (e.g., page turning actions), or performing eye-tracking with respect to the student user.

In a further example embodiment, there is provided a method to automatically control access to applications and/or content, accessible via a portable computing device, using geographic location information. The method includes accessing location information identifying a current location (e.g. a geofence) of the portable computing device. Control information is accessed to identify a first educational application, but not a second application as being accessible using the portable computing device at the current location. Based on the location-based information and the control information, access to the first educational application is selectively enabled on the portable computing device, while access to the second application is concurrently restricted at the current location.

An interface may be provided to a supervising user (e.g., a teacher) to receive supervisor information, the method including generating control information based on the supervisor information. The supervising user may be associated with an educational institution, and the supervisor information may include venue information identifying a number of locations at the educational institution. Further, the supervisor information may identify each of the locations that are being associated with at least one educational subject, and the automatic generation of the control information may use the venue information to automatically identify the first application.

The control information may furthermore identify first content, but not second content, as being accessible via the first application at the current location. The method may further include selectively enabling access to the first content via the first educational application at the current location, while concurrently restricting access to second content and to the current location.

FIG. 1 is a schematic diagram illustrating an environment 100, within which example embodiments may be deployed. The environment 100 includes a defined location 102 including a network access device, in the form of a router 104, which provides access to users within the defined location 102 via a network 106 (e.g., the Internet) to a number of servers and databases. These servers include an access control server 108, which is coupled to an access control database 110, application servers 112, coupled to respective application databases 114, and content servers 116, coupled to respective content databases 118.

The defined location 102 may be an educational institution (e.g., a school campus) or a home environment. The router 104 provides both wired and wireless access to users within the defined location 102. For example, a supervising user 120 (e.g., a teacher, lecturer or parent) may have access via a computer system 122 and a wired connection to the router 104, and thus, through the network 106 to any one or all of the servers 108, 112, or 116.

The supervising user 120 may desire to implement access control with respect to applications and/or content by student or child users 124 and 126. Each of the users 124 and 126 may have access via respective portable computing devices 128 and 130 (e.g., smart phones, tablet computers or laptop computers) to any number of applications installed on the respective machines 128 and 130. The portable computing devices 128 and 130 are furthermore shown to be connected, via a wireless network device 132, to the router 104, and hence via the network 106 to each of the servers 108, 112 and/or 116.

One or more NFC tags 134 may also be deployed in the defined location 102. The NFC tags 134 are readable by the mobile computing devices 128-130 so as to enable these devices to determine a current location. For example, where the defined location 102 is a school campus, the NFC tags 134 may be distributed throughout the campus so as to tag buildings, classrooms or even desk locations within classrooms. Furthermore, NFC tags 134 may be deployed in recreational areas on a school campus to identify these locations as such.

Each of the portable computing devices 128-130 may have a number of local applications installed thereon, together with associated local data stores. For example, where the portable computing device 128 is a tablet computer (e.g., an iPad), both educational applications (e.g., an electronic book reader application) as well as recreational or entertainment applications (e.g., a gaming application) may be installed locally on the device 128. Data specific to each of these applications (e.g., an electronic textbook or game data) may also be stored on the portable computing device 128.

In addition to having access to locally stored and hosted applications and content, the portable device 128 may also have access to any number of remote applications, served to the portable device 128 via respective application servers 122. Such remotely-accessed applications may again include both education and recreational applications. Content for such applications may also be stored remotely, for example within a remote content database 118, and served to the portable computing device 128 via content servers 116. Further, both applications and content may be divided between the local storage (e.g., on the device 128) and remote storage (e.g., in the databases 114 and 118).

The supervising user 120 further has access to the access control server 108 via the computer system 122. As will be described in further detail below, the supervising user 120 interacts with the access control server 108 to generate control data 140, which is in turn propagated from access control server 108 to each of the computing devices 128-130 in order to enable automatic access control functionality on these devices. To this end, each of the computing devices 128-130, in addition to the applications described above, may execute a local access control application, which is configured using the control data 140. While the access control application for the devices 128 and 130 is described herein as being locally hosted on the devices 130-130, in other embodiments, the access control application may be hosted remotely on the access control server 108. In this case, applications executed locally on the devices 128-130, or on the application servers 112, make calls (e.g., API calls) to the remote access control application (hosted on the access control server 108) in order to implement access control according to the access control data 140

FIG. 2 is a block diagram illustrating the architecture of mobile device software 200, which may be installed on any one or more of the mobile devices 128-130. The software architecture 200 is composed of a software stack of different layers, namely operating system layer 202, runtimes 204, libraries 206, application frameworks/APIs 208 and applications 210. The operating system 202 includes one or more kernels 212, drivers 214 and other services 216.

The kernel 212 acts as an abstraction layer between the hardware of a mobile device, and the other software layers. For example, the kernel 212 may be responsible for memory management, process management, networking, security settings etc. The drivers are responsible for controlling communication with the underlying hardware (e.g. for facilitating communication with Bluetooth hardware that may be used for NFC tag identification). The drivers 214 may include a display driver, camera driver, Bluetooth driver, flash memory driver, a USB driver, a keypad driver, a Wi-Fi driver, audio drivers and a power management driver.

The runtimes 204 may include virtual machines 218 (e.g. the Dalvik Virtual Machine or a Java Virtual Machine). Other example runtimes may include Objective-C runtime, which includes both the Objective-C dynamically-linked runtime libraries and the underlying C libraries.

The libraries 206 enable a mobile device to handle different types of data. The libraries may be written in C/C++ and are accessed via Java interfaces. The libraries include a surface manager for compositing windows, 2D and 3D graphics, media codex (e.g., MPEG4, H264, MP3 etc.) and SQL database (e.g., SQL light) and a native web browser engine (e.g., WebKit). Example libraries include a surface manager library that enables direct drawing on the screen, a media framework that provides media codecs allowing for the recording or playback of different media formats (e.g., MPEG4, H264, MP3 etc.), an OpenGL framework that is used to render 2D and 3D in a graphic content on the screen, and a WebKit that is a browser engine used to display HTMR content.

The application frameworks 208 may include an activity manager that manages the activity lifestyle of applications, a contents provider that manage data sharing between applications, a view system that handles GUI-related tasks, a telephony manager that manages voice calls, a location manager 236 that provides location-based services (e.g., using GPS or NFC information and supporting fine-grained location providers such as GPS and coarse-grained location providers such as cell phone triangulation), and a resource manager that manages various types of resources used by the applications 210.

The applications 210 include a home application 250, a contacts application 252, a browser application 254, a book reader application 256, education applications 258-260, gaming applications 262-264, and an access control application 266. Further details regarding an example access control application 266 are provided herein.

Operationally, the applications 210 may perform API calls 270 through the software stack of the architecture 200 and receive messages 272 in response to such API calls.

FIG. 3 is a block diagram illustrating the architecture of an access control application 300, according to an example embodiment. As has described with reference to FIGS. 1 and 2, in one example embodiment, the access control application 300 may be hosted and executed locally on a portable computing device 128. In other embodiments, the access control application 300 may be a remote application (e.g., a web application) executed on an access control server 108, and be accessed by supervising users 120 and student users 124 from 126 via the network 106. The access control application 300 includes a number of modules, including an application restriction module 302, an engagement module 304, a student user module 306, a supervising user module 308 and an interfaces module 310.

The application restriction module 302 is responsible for applying and removing restrictions with respect to access to applications accessible via a computing device. In one embodiment, the restriction module 302 may apply various degrees of restriction, including complete disablement or enablement of a particular application. Accordingly, the application restriction module 302 may restrict certain functions on a particular application, or may totally disable access to that particular application.

The engagement module 304 is responsible for measuring parameters related to user engagement with respect to application or content, and for calculating an engagement value representative of such a user engagement. To this end, the engagement module 304 may include timer, counter, eye tracking, facial recognition, and testing functions.

A student user module 306 is accessible to users (e.g., the student users 124 and 126) in order to manage log in and credential verification with respect to the student user, monitor and communicate regarding application activity, and activate rewards that are presented to the student user.

The supervising user module 308 likewise manages log in functions and credential management for supervising users (e.g., the supervising user 120.) The supervising user module 308 includes an activity specification sub-module that allows a supervising user to identify particular activity applications (e.g., a particular educational application), to specify activities to be performed using that application (e.g., reading a certain number of pages of an electronic book presented by an electronic book application), and also specify activity parameters (e.g., duration, amount of engagement etc.). The activity specification sub-module may include a question/interview process, which presents a guided questionnaire through which the supervising user is prompted for activity specification and information that is used to generate control data 312, according to which the application restriction module 302 may restrict access to one or more applications.

The supervising user module 308 also includes a reward specification sub-module that allows a supervising user (e.g., supervising user 120) to specify rewards to be presented once a student user (e.g., student users 125 and 126) have complied with the requirements of an activity specification (e.g., as expressed in the control data 312). Such reward specifications may include the lifting of restrictions from access to a particular application by the application restriction module 302. Other reward specifications may present the rewards described above. The reward specification sub-module may also include a questionnaire/interview process, which provides a guided process prompts the supervising user to provide reward specification information.

Finally, the interfaces module 310 provide inter-application interfaces whereby the restriction module 302 can send messages (e.g., through the software described above) to apply and remove restrictions with respect to user access to other applications. In this way, for example referring to FIG. 2, the access control application 266, may apply and remove restrictions with respect to the game applications 262-264 of a particular mobile device.

FIG. 4 is an entity-relationship diagram illustrating some example tables that may be included the control data (e.g., the control data 312 shown in FIG. 3 or the control data 140 shown in FIG. 1). The control data 400 includes a user data table 402, a control data table 404, a required activity data table 406, a monitored activity data table 408, an activity data table 410 and a reward data table 412. Each record in the control data table 404 includes a user identifier that indexes to a user record in the user data table 402, a required activity identifier that indexes to a required activity record in the table 406, a monitored activity identifier that indexes to a monitored activity record in the table 408, a reward identifier that indexes to a reward record in the reward data table 412, and a location identifier, specifying a location at which the activity may validly be performed.

It will be noted that records in the user data table 402 include both facial image data (e.g., one or more images of a user that allow for facial recognition of the user to be performed) and retina data that allows for retinal verification of the identity of a particular user.

Each record in the required activity data table 406 includes an activity identifier that indexes to an activity record the activity data table 410, a duration required value indicating a required duration for the specified activity, and an engagement requirement value corresponding to a determinable degree of engagement for the required activity. Similarly, the monitored activity data table 406 includes activity identifiers, indexing into records in the activity data table 410, measured duration values indicating measured duration of activity, and measured engagement values indicating a measured degree or amount of engagement for a particular activity. The records (or entries) within the monitored activity data table 408 may be updated on a periodic basis by the access control application 300 as it monitors activity performed by a user.

The reward data table 412 stores reward data entries (e.g., received by the reward specification sub-module of the supervisor user module 308.) Each record in the table 412 includes a reward identifier, a reward type, and an application identifier. The application identifier may identify a particular application (e.g., a recreational or entertainment application) to which a student user may be provided access as a reward for having completed a required activity.

Each record in the activity data table 410 includes an activity identifier, as well as an application identifier, identifying one or more applications to be used in performance of an activity specified by required activity data or monitored activity data.

FIG. 5 is a flow chart illustrating a method 500, according to an example, to automatically control access to an application accessible on or via a computing device. The method 500 is described below with respect to automatically controlling access to an educational application (or program) executing on a mobile computing device. It will however be appreciated that access to any type of application may be controlled.

The method 500 commences at operation 502, and proceeds to operation 504, where required activity data is received from a supervising user via an interface. For example, a supervising user 120 may provide the required activity data, using the supervising user module 308 of an access control application 300. In one example embodiment, the required activity data is solicited by the supervising user module 308 via the questionnaire/interview process. An example of an interface via which the required activity data may be provided by the supervising user is shown in FIG. 8. The received required activity data may then be used to create a record within the required activity data table 406 shown in FIG. 4.

Similarly, at operation 506, reward data is received from the supervising user via an interface of the access control application. For example, the reward specification sub-module of the supervising user module 308 of the access control application 300 may prompt the supervising user for reward information. In one example embodiment, the reward data may specify that restrictions on certain applications (e.g., recreational or entertainment applications) be removed on satisfaction of constraints specified by the required activity data.

The reward data may also specify limits on the removal of such restrictions, such limits comprising time limits (e.g., the restrictions are only to be removed for a certain period of time) or location restrictions (e.g., the restrictions are only to be removed within a pre-defined geographic location or area). In other embodiments, the reward data may specify a particular reward (examples of which are provided herein) can be provided to the user on satisfaction of requirements or constraints in the requirements activity data.

At operation 506, the activity/reward control data is created. In one example embodiment, the control data table 404 is populated. As above, the control data may comprise of the control data 140 shown in FIGS. 1 and 4 of the control data 312 shown in FIG. 3.

At operation 510, access to the computer device by a student user is detected. Responsive to this detection, at operation 512, access is enabled to one or more applications indicated in the control data to be associated with or needed for the required activity. Further, at operation 512 access to other applications is restricted (e.g., disabled), again in accordance with the control data. Considering the example in which the control data specifies that a student user is to read a certain number of pages of an electronic textbook, presented by a book reader application and to complete a mini-quiz related to those pages. The quiz maybe presented by a quiz application. In this example, the book reader application and the quiz application may be enabled at operation 512. Access to all other applications may be restricted (e.g., disabled) at operation 512. In a further embodiment, as opposed to restricting access to all other applications, a certain group or type of application may be disabled at operation 512. For example all applications identified as being recreational or entertainment applications may be restricted at operation 512, while access to all other applications (including the application required to perform the required activity) may be maintained (or enabled).

At operation 514, the access control application monitors an amount of activity and/or engagement by a student user, with respect to the required activity. In an example embodiment, the engagement module 304 may measure various parameters with respect to the activity of the student user with respect to the application.

At operation 514, a single value may furthermore be calculated as representative of the amount of activity and/or engagement by the student user. Any one or more of the activity and/or engagement measures described above may be used in this calculation, and different weights may be applied to different factors. The weighting of the factors may depend upon the type of application and may vary from required activity to required activity.

Further details regarding the measurement of activity and engagement, and calculation of an engagement value representative of engagement level are described below with reference to FIG. 6.

At decision operation 516, a decision is made by the access control application 300 as to whether a threshold amount of activity and/or engagement has been measured for the student user. To this end, a calculated activity and/or engagement value may be compared against a stored threshold (e.g., as expressed by the duration requirement or engagement requirement information within an appropriate record of the activity data table 406).

Assuming that the threshold is deemed to have been transgressed at a decision operation 516, a reward may then be provided to the student user. In one example embodiment, the reward, as defined by reward data in a record of the reward data table 412, may comprise a lifting or removal of restrictions on other applications (e.g., entertainment applications). For example, once a student user has read a required number of pages of an electronic book, using the book reader application and completed a mini-quiz on the content, access to a gaming application may be enabled at operation 518. As mentioned herein, other rewards may also be made available to the student user at operation 518.

On the other hand, should it be determined at the decision operation 516 that the activity and/or engagement threshold has not been transgressed, the method 500 continues to monitor activity and/or engagement, without dispensing or making available a reward.

FIG. 6 is a flow chart illustrating a method 600, according to an example embodiment, of measuring and calculating engagement and/or activity amount for a required activity. In one example embodiment, the method 600 may be performed at operation 514 of the method 500 shown in FIG. 5.

The method 600 commences at operation 601, and advances to operation 602 where one or more applications associated with the required activity are identified. In an example embodiment, the identification of the relevant applications uses the application identifier data in an activity data table record linked to a record in the required activity data table 406. While a single application may be needed to perform the activity, in some embodiments multiple applications may be needed. For example, where an electronic book reading activity is required, both an electronic book application and a mini quiz application may be required to complete a reading and test activities included within an overall required activity.

At operation 604, restrictions on the identified application (or applications) are removed (e.g., the required applications are unlocked and enabled).

At operation 606, a timer may be activated and started. The timer may record a duration of time that the application is activated and/or during which input is received into the application from the student user.

At operation 608, a counter may be activated and started. The counter may count discrete operations or inputs by the student user with respect to the required application (e.g., the counter may count a number of page turns of an electronic book being presented by a book reader application).

At operation 610, engagement measuring functionality may be activated and started. One example engagement measuring function may involve eye tracking implemented by the engagement module 304, which receives input from one or more cameras and/or infrared devices incorporated into or communicatively coupled with a portable computing device. The eye tracking functionality tracks eye movement of the student user to provide a measure of engagement. Again, for example, where an electronic book is being presented in the book reader application, the eye tracking movement may track the path of the user's eye across text presented on the page. In one example embodiment, this eye tracking functionality may detect when a student user, seeking to avoid the required activity, simply turns pages of the electronic book after a pre-determined amount of time without actually engaging and reading the content. In this situation, upon detecting that a user is not actually reading the electronic book, the eye tracking functionality may either alert a supervising user or pause the timer or counter until user engagement with the actual content is again initiated by the student user.

Eye tracking functionality can also, of course, be used to detect user engagement with other types of applications, with gaze dwell time on certain information presented within a user interface being detected and measured to provide a further indication and measure of engagement of a user with the content.

Further engagement functionality that may be deployed at operation 610 include test or quiz functionality. Specifically, test functionality within the engagement module 34 may also periodically conduct mini-quizzes or other tests in an attempt to measure user engagement with the content. For example, where the educational application supporting the required activity is a math application, quizzes related to previously presented content may periodically be presented to the student user, or presented upon completion of certain operations or the reception of input from the student user.

At operation 612, facial recognition functionality may be activated and started. In one example embodiment, facial recognition functionality of engagement module 304 may detect a position of a user's face relative to a screen of the computing device as a measure of engagement. Consider a situation in which the face of the student user is absent from a certain zone within a screen of the mobile device, or is oriented in a direction indicating that the user is not engaging with the content presented on the screen. As described above with respect to the eye tracking functionality, when facial recognition functionality detects that the facial orientation of the user is such that engagement is unlikely, the timer and/or counter may be paused, or an alert generated. In addition, the facial recognition technology may be used to verify that the specified user (and not a substitute) is in fact the user engaging with the application. The facial image and/or retina data of a record within the user data table 402 may be used at operation 612 to verify the identity of the student user. In other embodiments, the biometric information (e.g., fingerprint data) may be used to verify the identity of the student user.

At operation 614, an engagement amount and/or an activity amount for the required activity is calculated. The engagement and activity amounts may be calculated and represented by respective activity and engagement of values that are stored within the monitored activity data table 408 as duration measured and engagement measured values. As noted above, a single value may be calculated as representative of the amount of activity and/or engagement by the student user. Any one or more of the activity and/or engagement measures described above may be used in this calculation, and different weights may be applied to different factors. The weighting of the factors may depend upon the type of application and may vary from required activity to required activity.

The method 600 terminates at operation 612. It will be appreciated that the method 600 may be performed continually as operation 514 within the context of the method 500. As such, the method 600 may be performed periodically (e.g. every 0.5 seconds) based on sampled activity and engagement data collected by various input devices of a portable computing device.

FIG. 7 is a flowchart illustrating a method 700, according to a further embodiment, of controlling access to applications accessible on or by a portable computing device based on location data. The method 700 commences at operation 702, and progresses to operation 704, where control information is received from a supervising user via an interface of the access control application. The control information may include required activity data (e.g., to populate a record within the required activity data table 406), user data (e.g., to populate a record within the user data table 402) and reward information (e.g., to populate a record within the reward data table 412). The control data received operation 704 further includes location data, identifying a geographic location or area within which the control information is enforced by an access control application. The geographic location may be specified as a particular geographic co-ordinate, or a distance from a specified geographic location. The geographic location may also be defined as a particular ‘geofence’, which may be specified with respect to one or more reference points and may be a regular shape (e.g. within a certain radius of GPS coordinates), or may be an irregular shape (e.g. defined by tracing of a geographic area on a map.)

At operation 706, access control data may be created, for example by populating the tables shown in FIG. 4, and particularly by updating the control data table 404.

At operation 706, student user access to a portable computing device may be detected responsive to which, at operation 710, the current location of the portable computing device may be detected.

The current location of a portable computing device may be detected in any number of ways including utilizing GPS data, using NFC tag data or using cellular triangulation data. In yet a further embodiment, location data may be inferred from wireless network access data (e.g. from information associated with a wireless access point in a classroom or on a school campus).

At decision operation 712, the current location of the portable computing device is compared to an access control location specified by the access control data. Specifically, in one example embodiment, the current location of the portable computing device may be compared to location data recorded in control data of the control data table 404.

If the current location is determined to correspond to a geographic location (or be within a geographic area) specified by the control data, the method 700 progresses to operation 714. At operation 714, the access control application enables access (or removes certain restrictions) to permitted applications and/or content, as specified by the access control data, while restricting (e.g., disabling) access to other applications and/or content.

On the other hand, should the current location of the portable computing device be determined at operation 712 not to be within a control location (e.g. a geographic location) specified by the access control data, access control (e.g. by the application restriction module 302) is de-activated at operation 716.

FIG. 8 is a user interface diagram illustrating a supervising user interface 800, according to an example embodiment, using which a supervising user can input required activity data, control data and/or reward data to an access control application.

FIG. 9 is a user interface diagram illustrating a student user interface 900, according to an example embodiment, in which a first set of applications 902 have been enabled by an access control application for access by a student user while a second set of applications 904 have been disabled, in accordance with control data and constraints/requirements expressed in that control data. It will be noted that icons associated with the first set of applications are visually distinguished from icons associated with the second set of applications so as to indicate the status of these applications, and visually indicate that access to the second set of applications has been restricted.

FIG. 10 is a user interface diagram illustrating a student user interface 1000, according to an example embodiment, in which a reward message is presented to a student user.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of machine in the example form of a computer system 1100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

In some embodiments, the example computer system 1100 may be a portable computing device, such as a smart phone or tablet computer, and have a number of additional input components 1130 such as an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., an accelerometer), an altitude detection component (e.g., an altimeter), and a gas sensor. These components may be used as to harvest any one or more of the inputs described herein.

### Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of automatically controlling access to applications accessible on or via a computing device, the method comprising:
enabling access, by a user, to a first application via the computing device, while concurrently disabling access to a second application that would have otherwise been accessible via the computing device;
using at least one processor, detecting a predetermined amount of engagement by the user with the first application; and
responsive to the detection of the predetermined amount of engagement, selectively enabling access to the second application via the computing device.

2. The method of claim 1, wherein the first application is an educational application, and the second application is a recreational application.

3. The method of claim 1, wherein the first application enables access exclusively to educational content, and the second application enables access to recreational content.

4. The method of claim 1, wherein the disabling of the access to the second application includes accessing control data, and determining from the control data that the access to the second application is to be disabled until the detection of the predetermined amount of engagement with the first application.

5. The method of claim 4, wherein the control data specifies the predetermined amount of engagement by the first user with the first application.

6. The method of claim 4, including receiving input from a supervising user, and automatically generating the control data based on the input from the supervising user.

7. The method of claim 6, wherein the receiving of input from the supervising user comprises soliciting information from the supervising user regarding at least one of the users, identification of the first application, a desired amount of engagement with the first application, and identification of the second application.

8. The method of claim 1, wherein the detecting of the predetermined amount of engagement includes measuring a duration of time that the user engages with the first application.

9. The method of claim 1, wherein the detecting of the predetermined amount of engagement includes measuring activity of the user with respect to the first application.

10. The method of claim 7, wherein the measuring of the activity of the user includes monitoring input by the user with respect to the computing device.

11. The method of claim 7, wherein the measuring of the activity of the user includes performing eye tracking with respect to the user.

12. A method of automatically controlling access to applications accessible on or via a portable computing device, the method comprising:
accessing location information identifying a current location of the portable computing device;
accessing control information identifying a first educational application, but not a second application, being accessible, via the portable computing device, at the current location; and
based on the location information and the control information, selectively enabling access, using the portable computing device, to the first educational application at the current location, while concurrently restricting access to the second application at the current location by the portable computing device.

13. The method of claim 12, including providing an interface to a supervising user, the interface to receive supervisor information, and automatically generating the control information based on the supervisor information.

14. The method of claim 13, wherein the supervising user is associated with an educational institution, and the supervisor information includes venue information that identifies a plurality of locations at the educational institution as each being associated with at least one of educational subject and educational class, the automatic generation of the control information using the venue information to automatically identify the first application.

15. The method of claim 14, wherein the control information identifies first content, but not second content, as being accessible via the first application at the current location, the method further including, based on the location information and the second information, selectively enabling access to the first content via the first educational application at the current location, while concurrently not permitting access to the second content at the current location.

16. A system to automatically control access to applications accessible on or via a computing device, the system comprising:
a processor-implemented application restriction module to permit access, by a user, to a first application via the computing device, while concurrently restricting access to a second application accessible via the computing device; and
a processor-implemented engagement module to detect detecting a predetermined amount of engagement by the user with the first application; and
the restriction module further, responsive to the detection of the predetermined amount of engagement, selectively to remove the restricted access to the second application via the computing device.

17. The system of claim 16, wherein the first application is an educational application, and the second application is a recreational application.

18. The system of claim 16, wherein the first application enables access exclusively to educational content, and the second application enables access to recreational content.

19. The system of claim 16, wherein the restriction module is to access control data, and to determine from the control data that the access to the second application is to be restricted until the detection of the predetermined amount of engagement with the first application.

20. The system of claim 16, wherein the engagement module is to detect the predetermined amount of engagement by measuring a duration of time that is the user engages with the first application.

21. The system of claim 16, wherein the engagement module is to detect the predetermined amount of engagement by measuring activity of the user with respect to the first application.

22. The system of claim 7, wherein the engagement module is to perform eye tracking with respect to the user in order to measure activity of the user with respect to the first application.

23. A system of automatically controlling access to applications accessible on or via a portable computing device, the system comprising:
a restriction module to:
receive location information identifying a current location of the portable computing device;
access control information identifying a first educational application, but not a second application, being authorised at the current location; and
based on the location information and the control information, selectively enable access to the first educational application at the current location, while concurrently restricting access to the second application at the current location by the portable computing device.

24. The system of claim 23, including a supervising user interface to receive supervisor information, and automatically to generate the control information based on the supervisor information.

25. The system of claim 23, wherein the supervising user is associated with an educational institution, and the supervisor information includes venue information that identifies a plurality of locations at the educational institution as each being associated with at least one of educational subject and educational class, the automatic generation of the control information using the venue information to automatically identify the first application.

26. The system of claim 23, wherein the control information identifies first content, but not second content, as being accessible via the first application at the current location, the restriction module, based on the location information and the second information, selectively to enable access to the first content via the first educational application at the current location, while concurrently restricting access to the second content at the current location.
